(19) United States
(12) Patent Application Publication
(10) Pub. No.: US 2012/0239578 A1
(43) Pub. Date: Sep. 20, 2012

(54) Mobile Secure Transactions Using Human Intelligible Handshake Key

(75) Inventors: Richard Kang, Irvine, CA (US); Lance Taschner, Irvine, CA (US)

(73) Assignee: ALLEGRO SYSTEMS LLC, Lake Forest, CA (US)

(21) Appl. No.: 13/088,948

(22) Filed: Apr. 18, 2011

Related U.S. Application Data
(60) Provisional application No. 61/453,837, filed on Mar. 17, 2011.
(60) Provisional application No. 61/454,264, filed on Mar. 18, 2011.

(51) Int. Cl. G06Q 20/00

(52) U.S. Cl. 705/71

(57) ABSTRACT

A software library could be called by an ecommerce application on a mobile phone to improve security of the transaction. When a human user wishes to purchase a product through the ecommerce application, the software library could present a passkey, such as a unique word, phrase, image, sound, or song, which is only recognizable by the human user. The human user authenticates the passkey by recognizing the passkey as the one he/she designated, and then authorizes the payment for the product, preferably through a passkey of his or her own, such as a password that the system recognizes.

This application claims the benefit of priority to U.S. Patent Provisional No. 61/453837, filed Mar. 17, 2011, and to U.S. Patent Provisional No. 61/454264, filed Mar. 18, 2011, both of which are incorporated by reference in their entirety herein.

### FIELD OF THE INVENTION

The field of the invention is secure transactions on mobile devices

### BACKGROUND

Ensuring the security of online transactions is of paramount importance to both consumers and corporations alike. Consumers need to be certain that their financial information is safe from identity theft predators. Corporations need to protect the goodwill of their brand so that consumers will return to do business with the corporation in the future, and will recommend friends. Any actual or perceived weakness in an online security transaction could harm both parties in any number of ways.

US20110031310 to Wilson teaches a system and method to improve security for online financial transactions by providing a cryptographic private key securely stored in the storage device of a user that requires a public key to complete a handshake. Use of public and private keys, however, is invisible to a user and fails to provide users with ease of mind for a secure transaction.

Wilson and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

US2008/0229109 to Gantman teaches a website for making online banking transactions that uses human-recognizable cryptographic keys, which allows a user to view and understand the private key that is exchanged with the online banking service, giving the user ease of mind that the banking institution is, indeed, a trusted source. For only a trusted source would be able to show the user the private key being used. Gantman, however, only contemplates use of human-recognizable cryptographic keys between a user and a single banking institution, and requires a user to create a new human-recognizable cryptographic key for each different institution.

Therefore, there remains a considerable need for method, systems, or configurations to ensure the authenticity and security of a mobile financial transaction and to ensure authenticity and security of a consumer's mobile wallet and their payment sources.

It has yet to be appreciated that a financial institution could use a human-recognizable cryptographic key to allow a user to authenticate a transaction with third party companies. Thus, there is still a need for improved security systems that provide both security and ease of mind to a consumer.

### SUMMARY OF THE INVENTION

The inventive subject matter provides apparatus, systems and methods in which one can securely authenticate a transaction by providing a human-intelligible passkey to a user prior to making a transaction so that the user can authenticate the transaction.

The transaction security module could be provided as a customized portion of any suitable transaction application, for example an ecommerce application, a peer to peer money payment application, or an international money transfer application. As used herein, an “application” is any method implemented on a computer system to perform a task, such as an interactive website (preferably HTML5) or a computer program installable on such a computer system. In preferred embodiments, the transaction security module is linked to a transaction application using a separate SDK (Software Developer Kit), a library, a cookie, or an OAuth (Open Authorization) package. In this manner, for example, the amazon.com™ website could give an OAuth package to a website transaction security module with some basic information (i.e. a username and a product price) to access a user interface that shows the human-intelligible passkey when a user wishes to conduct a transaction on amazon.com's website, and the website transaction security module could return a verified OAuth package if that user authorizes payment through the website transaction security module. Or, in an alternative example, an ebay.com™ software application could access an SDK to invoke an application transaction security module that shows the human-intelligible passkey in its own user interface. The user then authenticates the passkey by indicating through the user interface that the user has recognized the passkey. Authentication could take a variety of forms, for example, the user could check an “OK” box, the user could click accept, or the user could input an account passkey of its own, for example by inputting an alphanumeric password or by saying a voice-recognized word. If the human-intelligible passkey has been properly authenticated, the transaction security module could inform the transaction application that the transaction has been approved.

As used herein, a “human-intelligible passkey” is a passkey that is shown to a human which a human being of average intelligence would recognize. For example, an average human may recognize a word or a short phrase, but would not recognize a 16-digit alphanumeric phrase that contains no actual words. Or an average human may recognize an image of a duck over an image of a pig, but would not recognize an image of a forest of 50 similarly sized trees with over an image of a forest of 49 similarly sized trees. A human-intelligible passkey could be output through the user interface using any of the five senses, but is preferably output through a GUI (Graphical User Interface) or through a speaker of the user interface. Exemplary human-intelligible passkeys include alphanumeric passwords or phrases, sounds or music files, images, or combinations thereof, such as a video file. Such human-intelligible passkeys could be selected or compiled from a library of such passkeys, or are preferably created by a user and uploaded to a memory accessible by the transaction security module.

The transaction security module is preferably set up to authorize the transfer of funds from a transaction account associated with the user to a destination transaction account—preferably a third-party transaction account. As used herein, a third-party transaction account is an account that is not owned or controlled by either the user nor the transaction security entity. As a result of these permissions, the transaction security entity can only transfer funds to and from the third-party transaction account with authorization from the third party, just like the transaction account can only transfer funds to and from the user account with the user's permission. For example, where the transaction security is a SaaS business for amazon.com™, the transaction account for amazon.comTM would be a third-party transaction account, where a transaction account for the SaaS would be a transaction account owned and controlled by the SaaS business. In some embodiments, the system may be set up such that the transaction security only requires authorization from either the user or the third-party when transferring funds from the user's or third party's account, respectively, and does not need such authorization when transferring funds to the user's or the third party's account, respectively. The destination account could, however, be owned and controlled by the transaction security entity without departing from the scope of the invention.

The transaction security module is preferably set up on at least two computer systems: a first computer system that has access to the user-transaction account and the destination transaction account, and a second computer system that has access to the ecommerce application and the user interface that presents the human-intelligible passkey. Preferably, the second computer system is a mobile computer system that allows a user to access the ecommerce application from any location with a wi-fi or cellular data signal. As used herein, a mobile computer system is any computer system that is less than ten pounds, preferably less than five or two pounds, that could be held in an average human hand with the palm-side down. Contemplated mobile computer systems include laptops and tablet computers, but are preferably telephony devices, such as an iPhone™, an Android™ phone, or a Blackberry™ phone.

The first computer system that has access to the user-transaction account could gain access to the user-transaction account in a variety of ways. For example, the first computer system could have a user interface that receives an account number and a routing number for a bank debit account, or could receive a credit card number and corresponding authorization information (i.e. exp. date, conf. code) for a credit account, or could receive a gift card number for a gift card debit account. Alternatively, the first computer system could have a user-transaction account that is pre-paid with cash funds from the user, so that the user does not need a banking institution or a credit card to pay for items using the user-transaction account. A user could give cash to any retail business with deposit-access to the user-transaction account, and that cash could be added to the user's account. In another embodiment, the first computer has a program that accesses a transaction account with such corresponding information, such as a Google™ checkout account or a Paypal™ account.

The system could also automatically select preferred sources of funds associated with the user-transaction account for payment without user intervention. For example, the system could automatically select a credit card account if the user has used the credit card account more than any other source of funds for a period of time, such as in the last month, two months, half a year, or year. Or the system could have a set of preferred sources of funds in a hierarchical order, for example setting gift cards as the most preferred source of funds, then credit cards, and finally debit cards. The system could also be set to associate gift cards with associated vendors, and credit cards with associated product points. For example, a first credit card with a larger point return for flights could be preferred for flights, while a second credit card with a larger point return for meals could be preferred for restaurants and grocery stores. In an exemplary embodiment, the fund preferences are manually set by the user, since one user might prefer paying using credit cards, and another user might prefer paying using a debit account.

An example of a method in accordance with the inventive system would generally begin by a user accessing an ecommerce application, such as a website or a mobile application, to browse through goods or services that are offered by the ecommerce application. When the user selects a product to purchase, the mobile application then invokes the security transaction module through a software library or SDK. The user interface of the security transaction module then transmits the human-intelligible passkey to the user for authentication. If the user recognizes the human-intelligible passkey, then the user could then acknowledge that he has authenticated the human-intelligible passkey by inputting an account passkey of his own into the user interface. The security module then checks the account passkey against its database to authenticate the user, and selects a preferred fund source to pay for the good or service originally selected by the user. The user could then review the entire transaction, including the product purchased, the price, the source of funds selected, and/or the method of delivery, and either makes appropriate changes, or confirms that the transaction should occur. Lastly, the transaction security module sends a message to the transaction application that the transaction has been approved and that the funds from the user's transaction account will be transferred to the account managed by the ecommerce application. The user is then returned back to the normal user interface of the ecommerce application to continue shopping or to close the application.

The user generally registers her user-transaction account with a separate user transaction account application, for example a website or a mobile telephony device application. The user generally enters in unique identifying information, such as a name, pseudonym, address, telephone number, email-address, mobile phone number, or combination thereof, and creates an account passkey used to authenticate the user when the user wants to access her user-transaction account. The user also selects a human-intelligible passkey to be used so that the user could authenticate the transaction security module, and that is sent to the user anytime a transaction application asks the user for her account passkey, so that the user knows that the transaction is secure with a trusted intermediary. After these security settings are set, the user generally then loads the user-transaction account with funds from a credit cord, debit card, or from cash, or the user could link the user-transaction account to different sources of funds controlled by third parties.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an embodiment of the current invention.

FIG. 2 is a close-up plan view of a mobile computer system of the current invention.

FIG. 3 is a close-up plan view of the mobile computer system of the current invention with a separate user interface.

FIG. 4 is a schematic of an embodiment of the current invention with an NFC reader.

FIG. 5 is a schematic of an embodiment of the current invention used with a wireless check-in service.

### DETAILED DESCRIPTION

It should be noted that while the following description is drawn to a computer/server based transaction system for ecommerce applications, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

One should appreciate that the disclosed techniques provide many advantageous technical effects, including allowing a human user to authenticate the identity of a transaction security module asking for a passkey that grants access to a user's transaction account, and pre-selecting sources of funds as a matter of preferences set either by the transaction security module or the user herself

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

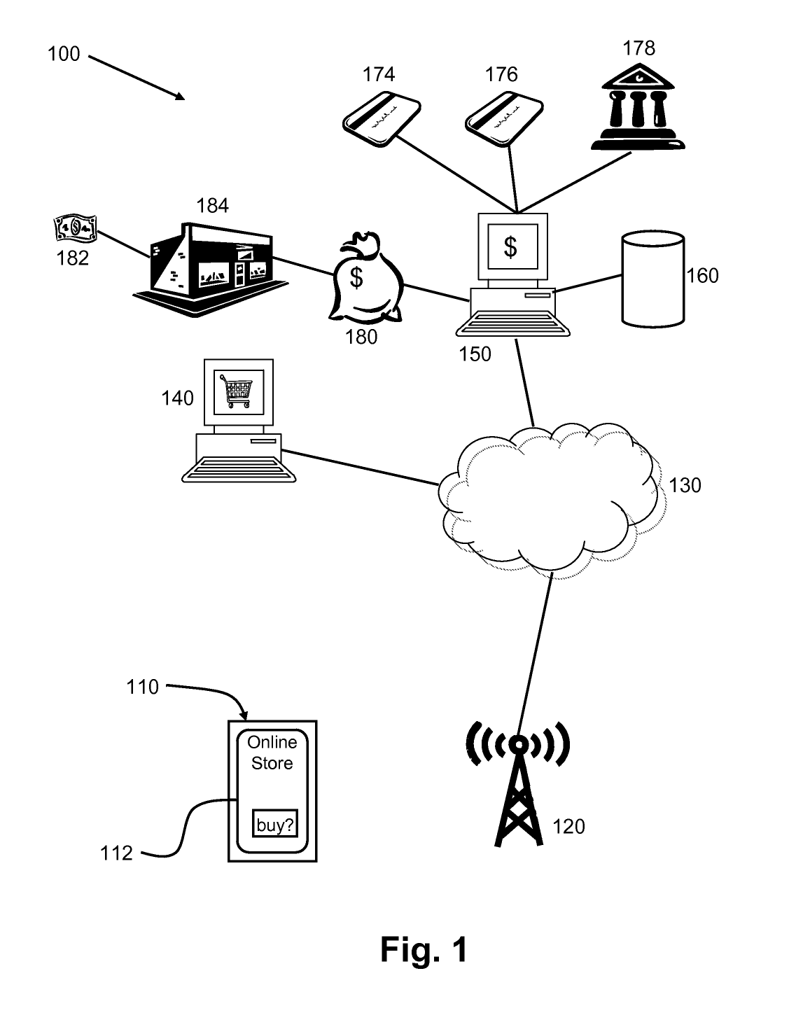

In FIG. 1, a system 100 generally comprises a mobile computer system 110, a transaction executing computer system 140, and a transaction account computer system 150. The mobile computer system 110 is represented here euphemistically as a mobile telephony device with a user interface 112 running a transaction application that is connected to network 130 via telephony data tower 120, however mobile computer system 110 could be any other computer system known in the art that could be coupled to network 130. User interface 112 is produced by an application installed on the mobile computer system 110, and allows a human user (not shown) to access the transaction executing computer system 140 via network 130 via a touch screen or microphone, although other user interface input devices are contemplated. While user interface 112 is produced here by an application, user interface could be produced by a dynamic website using, for example, HTML, Adobe™ Flash, or HTML5. The application installed on the mobile computer system 110 also allows the human user to access transaction account computer system 150 via network 130 when making a purchase.

Transaction account computer system 150 has account data on multiple users, and stores that data within database 160. That user information preferably contains information unique to the user, such as first name, last name, pseudonym, account access passkeys, address, telephone numbers, work addresses, billing addresses, and fund source information. Once a user creates his account on transaction account computer system 150, the user can also associate one or more fund sources to his account, such as a gift card 174, credit card 176, or pre-paid account 180. Pre-paid account 180 is an account controlled by transaction account computer system 150 that has an amount of pre-paid funds deposited by the user. While the pre-paid account 180 could be filled with funds from credit card 176 or bank account 178, pre-paid account 180 is preferably filled via cash 182 which could be deposited using pre-paid intermediary 184. Pre-paid intermediary 184 is represented herein euphemistically as a retail store, such as a Seven-11®, where a user could deposit funds into a pre-paid account using cash, but pre-paid intermediary 184 could be any suitable intermediary, for example a bank, a deposit ATM, or a cash advance business. By loading a pre-paid account 180 with such funds, a user could allow the transaction account system to make purchase without need to draw from a credit card or a banking institution.

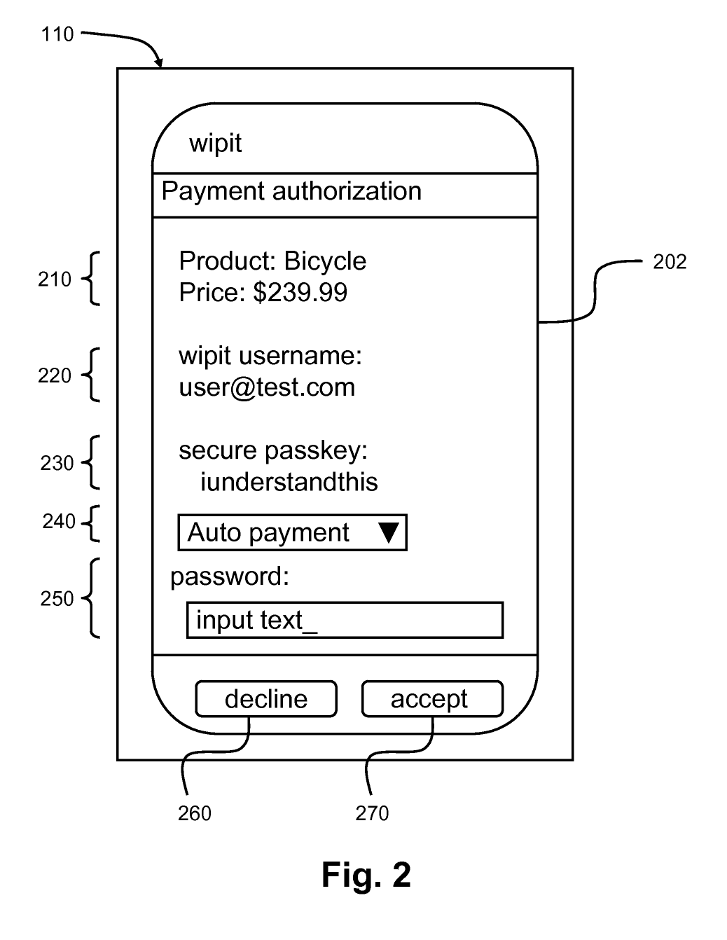

Whether the transaction executing computer system 140 is an ecommerce website, a peer to peer transaction service, or an international transfer service, the user could then initiate a command to transfer funds from an account controlled by the transaction account computer system 150 to an account controlled by the transaction executing computer system 140. Before authorizing such a transaction, the transaction application installed on mobile computer system 110 then invokes a user interface 202 as shown in FIG. 2. This user interface is generally a separate security module that is invoked by the transaction application via a library or an SDK, or website that is securely linked to along with transaction information loaded from the ecommerce computer system.

The user interface 202 generally shows product information 210, user information 220, the user's human-intelligible passkey 230, payment selection icon 240, and a user-account passkey input box 250. Product information 210 is generally information about the product that is being purchased by the user, for example the name of the product, the name of the merchant offering the product, the price of the product, where the product is being shipped from, the brand name of the product, any discounts applied to the product, and/or any shipping and handling fees. User information 220 generally shows the user unique information associated with the user's account, and human-intelligible passkey 230 generally shows a human-intelligible passkey that is also associated with the user's account. If the user recognizes human-intelligible passkey 230, then the user can input his account-passkey into input box 250 and hit the accept button 270. If the user does not recognize human-intelligible passkey 230, or wants to cancel the transaction for another reason, then the user could hit the decline button 260.

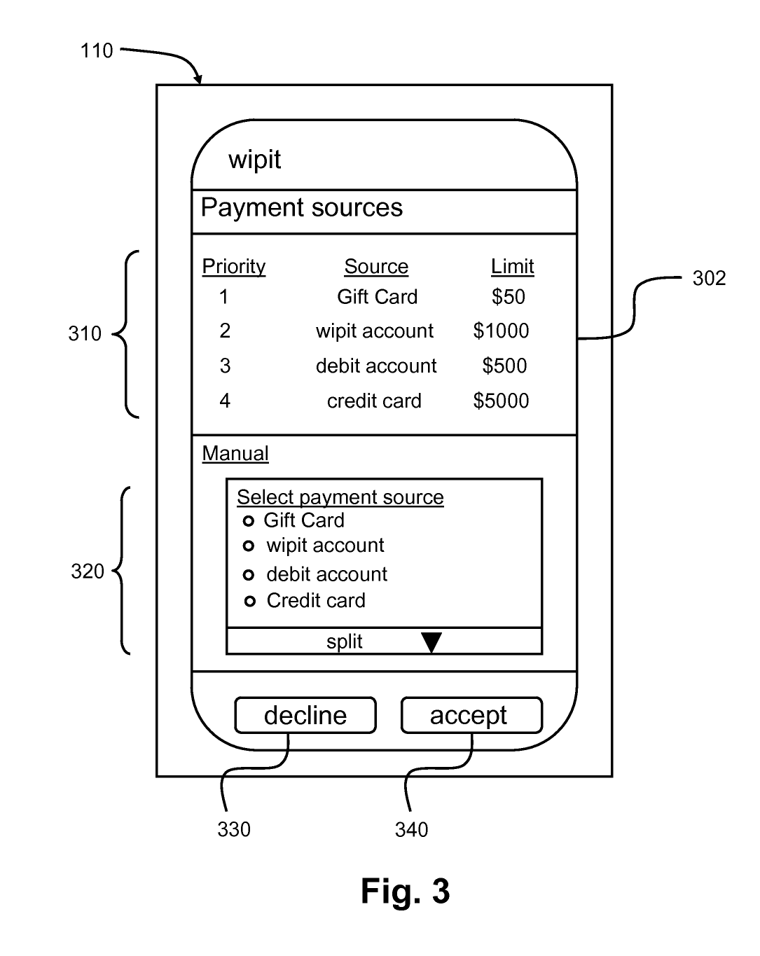

The payment selection icon 240 defaults to the preferred auto payment fund source associated with the user's transaction account, whose settings could be set by default according to a function or algorithm of the transaction business, or could be manually set by a user. However, the user could click on the payment selection icon 240 to select alternative payment fund sources. FIG. 3 has admin user interface 302 that shows an administration screen that allows a user to pre-configure the preferred auto payment fund source. As shown the preferred auto-payment fund sources are shown in 310, which shows each source, its priority compared to other sources, and the amount of funds that could be withdrawn by a user. Presently, a gift card source is set as the top priority, along with a pre-paid account as priority #2, a debit account as priority #3, and a credit card account as priority $4. If a requested transaction exceeds the limit of the top priority fund source, the computer system automatically selects the next priority account with funds that do not exceed that limit. In exemplary embodiments, the computer program could auto-split payment sources For example, for a purchase of a $150 item in which the top priority gift card is valid, the computer system could allow the first $50 of a purchase to be paid by the gift card and the next $100 to be paid by the pre-paid account. If any of the fields of the preferred auto-payment fund sources are incorrect, for example the order of priority or the amount of maximum limit a payment source could make, the user could touch the incorrect variable and make dynamic instructions before the secure transaction module is executed.

The admin user interface 302 of FIG. 3 also has a manual selection option 320, displaying all of the different contemplated payment sources. The manual selection option allows a user to select one or more default payment sources without regard to priority (since there is only one designated payment source) and allows the user to designate how multiple payment sources might split such a payment.

Where the security module has not been installed onto mobile computer system 110, the user interface 202 could be invoked by a separate client library that securely transfers information to transaction account computer system 150 without allowing transaction executing computer system 140 to access information sent to, and received from, transaction account computer system 150. This is especially important in embodiments where the user has yet to create a user account and account passkey or human-intelligible passkey, and must create both during a registration period.

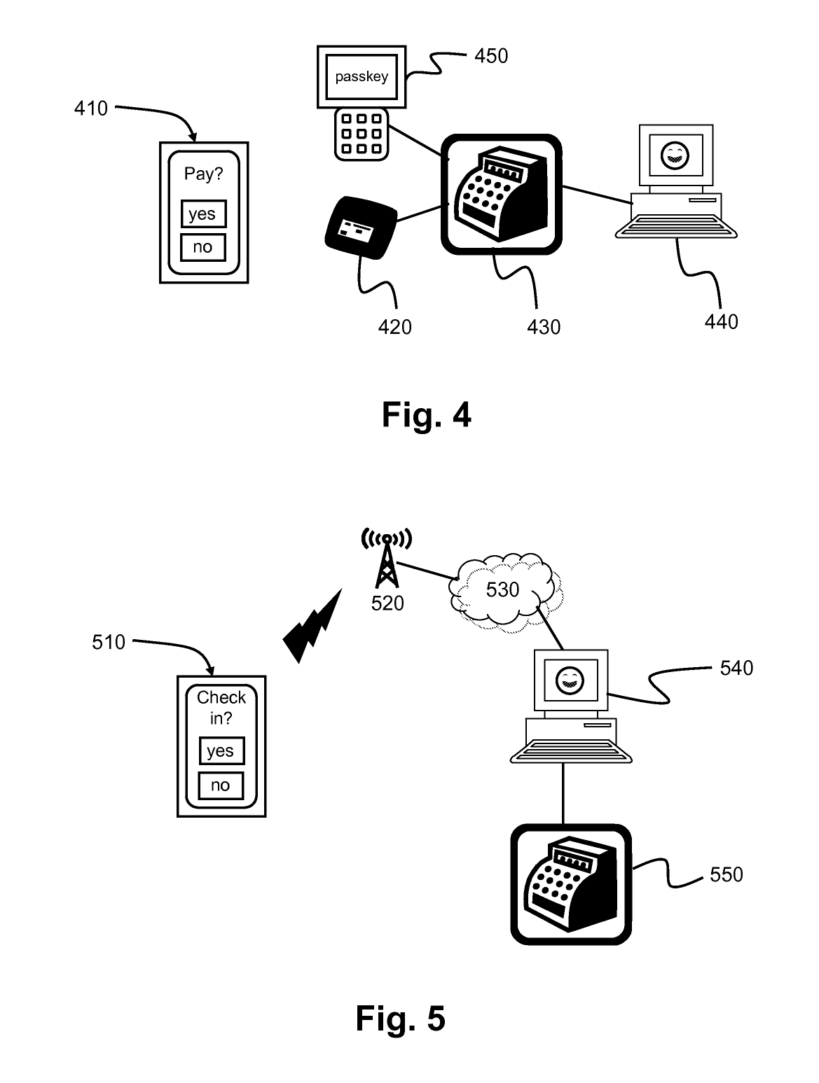

In FIG. 4, a store customer could authorize a transaction security module running on mobile computer system 410 to transmit account identity information to an NFC (Near Field Communication) device 420 coupled to a store's transaction device 430 so as to pay for a product or a service. Contemplated NFC devices include an RFID reader, a Bluetooth receiver, or an infrared receiver. When the NFC device receives a request to pay for an item from mobile computer system 410 using the customer's transaction account, the store's transaction device 430 could send a request through computer 440 to a transaction account computer system (not shown). That computer system could then transmit some authentication token for the store to authenticate the identity of the customer. Preferably, the authentication token comprises biometric information unique to the customer, such as a photo, a fingerprint scan, or a retina scan.

Once the store verifies that the user is a correct user, the store could send a request to debit a certain amount of money from the customer's transaction account, or preferably allows the customer to validate the store by presenting the human-intelligible passkey to the customer through validation terminal 450. If the customer recognizes his or her own human-intelligible passkey, the customer could then enter in an account passkey into validation terminal 450, such as an alphanumeric password or a pin number. In this way, the customer could use mobile computer system 410 to securely make and pay for a transaction without needing to carry around a wallet. In an alternative embodiment, the customer could use any NFC device to transmit account information to NFC reader 420, such as an RFID card or other suitable wireless transmitters.

In FIG. 5, an alternative system allows a user's mobile computer system 510 to check-in wirelessly via wireless transmitter 520 when the user wants to pay for an item in a store. In one embodiment, a transaction security module running on mobile computer system 510 could use a GPS locator on mobile computer system 510 to locate the name of the store, and could virtually “check in” with the store to authorize payment via a remote transaction account computer system (not shown). In an alternative embodiment, the user could enter the store's name into an online database to check in to the store. In either situation, once the user has “checked in” with the store and has authorized the store to debit payment from the user's account, the store could run through a similar background check of the user, for example by verifying the user's identity using biometric information through computer 540. Once the store sends a request to debit the user's remote transaction account, the remote transaction computer system could send a payment request wirelessly to the transaction security module on mobile computer system 510, which the user could then authorize.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for securing a transaction, comprising:
a network computer system with access to a user transaction account and an associated human-intelligible passkey;
a mobile computer system with a mobile application that presents a user interface allowing a user to request the mobile application to transfer money from the user transaction account to a business transaction account; and
a software library accessible by the mobile application that presents, in response to the requested transfer from the mobile application, the passkey to the user interface, wherein a human user authenticates the passkey and authorizes the software library to complete the requested transfer through the user interface.

2. The system of claim 1, wherein the user transaction account comprises a bank account or a checking account.

3. The system of claim 1, wherein the human-intelligible passkey is selected from the group consisting of an image, a set of alphanumeric characters, or a sound.

4. The system of claim 1, wherein the mobile application presents commercial items to the user through the user interface that the user could purchase using the requested transfer.

5. The system of claim 1, wherein the software library comprises an SDK (Software Developer Kit).

6. The system of claim 1, wherein the authorization for the software library to complete the requested transfer comprises the software library receiving a password through the user interface.

7. A method of securing a transaction within a mobile application, comprising:
receiving a request through a user interface on the mobile application to transfer money from a user transaction account to a third-party transaction account designated by the mobile application;
providing a user interface within the mobile application that presents a passkey through the user interface for human-user authentication;
receiving an authorization through the user interface to allow the requested transfer to execute; and
transferring funds from the user transaction account to the third-party transaction account.

8. The method of claim 7, wherein the user interface enables access to the user transaction account.

9. The method of claim 7, wherein the step of providing a user interface comprises providing a software library that is loaded by the mobile application.

10. The method of claim 7, wherein the passkey is selected from the group consisting of alphanumeric characters, an image, and a sound.

11. The method of claim 7, wherein the step of receiving an authorization through the user interface comprises receiving a password through the user interface.

12. The method of claim 7, further comprising providing a separate user interface that allows a user to designate the passkey.

13. The method of claim 12, wherein the step of designation comprises selecting the passkey from a set of potential passkeys.

14. The method of claim 12, wherein the step of designation comprises receiving the passkey from the user.

15. The method of claim 7, wherein the funds are selected from a group consisting of bank funds, credit card funds, and gift card funds.

16. The method of claim 7, further comprising automatically selecting a preferred user transaction account from a plurality of transaction accounts owned by the user.

17. The method of claim 16, wherein the preferred user account is a gift card account.

18. The method of claim 16, wherein the preferred user account is a debit card account.

19. The method of claim 7, wherein the steps are performed in sequence.
